(19) United States
(12) Patent Application Publication
(10) Pub. No.: US 2002/0158460 A1
(43) Pub. Date: Oct. 31, 2002

(54) Fender flare

(75) Inventor: Gerald A. Logan, Hillsboro, OR (US)

Correspondence Address: Kolisch, Hartwell, Dickinson,, McCormack & Heuser, 520 S.W. Yamhill Street, Suite 200, Portland, OR, 97204, US

(73) Assignee: Bushwacker, Inc.

(21) Appl. No.: 09/843,507

(22) Filed: Apr. 26, 2001

(51) Int. Cl. B62B 9/14

(52) U.S. Cl. 280/848; 280/849

(57) ABSTRACT

A fender flare having a body flare piece configured to be secured to a body portion of a vehicle, and a door flare piece configured to be secured to the door of the vehicle. Both pieces are secured near a wheel well of the vehicle, and collectively form an at least substantially continuous trim structure when the door of the vehicle is closed. The door flare piece includes inner and outer vehicle attachment members, which are configured to receive the door of the vehicle at least partially therebetween to secure the door flare piece to the vehicle door. The vehicle attachment members are configured to secure the door flare piece to the door of the vehicle without introducing holes into or otherwise structurally modifying the door of the vehicle.

### FIELD OF THE INVENTION

The present invention is related to vehicular fender flares having a flare piece that may be secured to a vehicle door without drilling holes into or otherwise structurally modifying the door.

### BACKGROUND OF THE INVENTION

Vehicular body extensions are installed on vehicles for a variety of aesthetic and functional reasons. Fender flares, for example, are often installed near the wheel well openings of a passenger vehicle, such as truck or sport-utility vehicles, to enhance the appearance of the vehicle. Fender flares may also be used to satisfy certain motor vehicle laws, for example those requiring that large tires be covered if they extend beyond normal wheel well openings. Fender flares may be installed during initial manufacture of the vehicle, though they are also commonly installed aftermarket to customize the vehicle.

Fender flares generally include an outer visible piece or section (the “flare member”) and some structure for securing it to the exterior of a vehicle near or around one of the wheel wells. To serve various aesthetic and functional purposes, the flare member is often quite large relative to the edge guards, trim pieces and other structures that are often secured to edges of fenders and doors. For example, the flare member is sometimes formed as a raised molding that extends outward from the vehicle body to provide an aggressive, bulked-up appearance. In addition to extending outward from the vehicle body, flare members tend to be fairly wide. For example, many flare members cover a several-inch wide arcuate strip of the vehicle body immediately adjacent the wheel well opening, and also extend radially inward beyond the edge of the wheel well opening defined by the vehicle fender.

Conventional methods for connecting the flare member to the vehicle typically account for the fact that fender flares can be fairly bulky and heavy. Bulk and heft render the flare susceptible to becoming dislodged due to wind, vibration, or simply as a result of its own weight. Accordingly, a firm connection between the vehicle and flare can be important. This is often provided using rivets, bolts, screws or similar fasteners that are passed through holes in the fender flare and the vehicle.

The holes required by the described conventional attachment method are often undesirable. This is particularly the case with aftermarket fender flares, or where it may be desired to later uninstall a fender flare, since the holes are often drilled in a location where they will be visible once the fender flare is removed. Individuals who lease vehicles are normally prohibited from drilling holes into the vehicle or performing other structural operations that would result in modification. Accordingly, they cannot customize their vehicles using the conventional fender flare described above without incurring additional fees or expenses. Drilling holes where they are not intended can produce unsightly results, and may cause or accelerate rusting. Further, drilling holes or otherwise structurally modifying the vehicle can complicate the process of installing the fender flare.

### SUMMARY OF THE INVENTION

The present invention provides a fender flare having a body flare piece and a door flare piece that are respectively secured to the body and door of a vehicle near a wheel well. The fender flare is configured so that when the door of the vehicle is closed, the two flare pieces collectively form an at least substantially continuous trim structure. The door flare piece includes inner and outer vehicle attachment members, which are configured to receive the door of the vehicle at least partially therebetween to secure the door flare piece to the vehicle door. The vehicle attachment members are further configured to allow the door flare piece to be secured to the vehicle door without introducing holes into or otherwise structurally modifying the vehicle door.

### BRIEF DESCRIPTION OF THE FIGURES

FIG. 1 is an isometric view of a representative vehicle on which a fender flare according to the present invention is installed.

FIG. 2 is an isometric view similar to FIG. 1, but showing the fender flare exploded off of the vehicle.

FIG. 3 is a cross-sectional view depicting the vehicle door shown in FIG. 1, and the flare piece that is secured to the door.

FIG. 4 is an isometric view of the door and flare piece shown in FIG. 3.

FIG. 5 is a sectional isometric view of the vehicle body shown in FIG. 1, depicting the flare piece that is secured to the vehicle body.

FIGS. 6 and 7 are fragmentary side elevation views of the vehicle door and door flare piece shown in FIGS. 1 and 2, and depicting a method of installing the door flare piece.

FIG. 8 is a cross-sectional view depicting the vehicle door shown in FIG. 1, and an alternately configured door flare piece secured to the vehicle door.

FIG. 9 is a cross-sectional view depicting another alternately configured door flare piece secured to the vehicle door shown in FIG. 1, and an alternately configured body flare piece secured to the vehicle body.

### DETAILED DESCRIPTION AND BEST MODE OF THE INVENTION

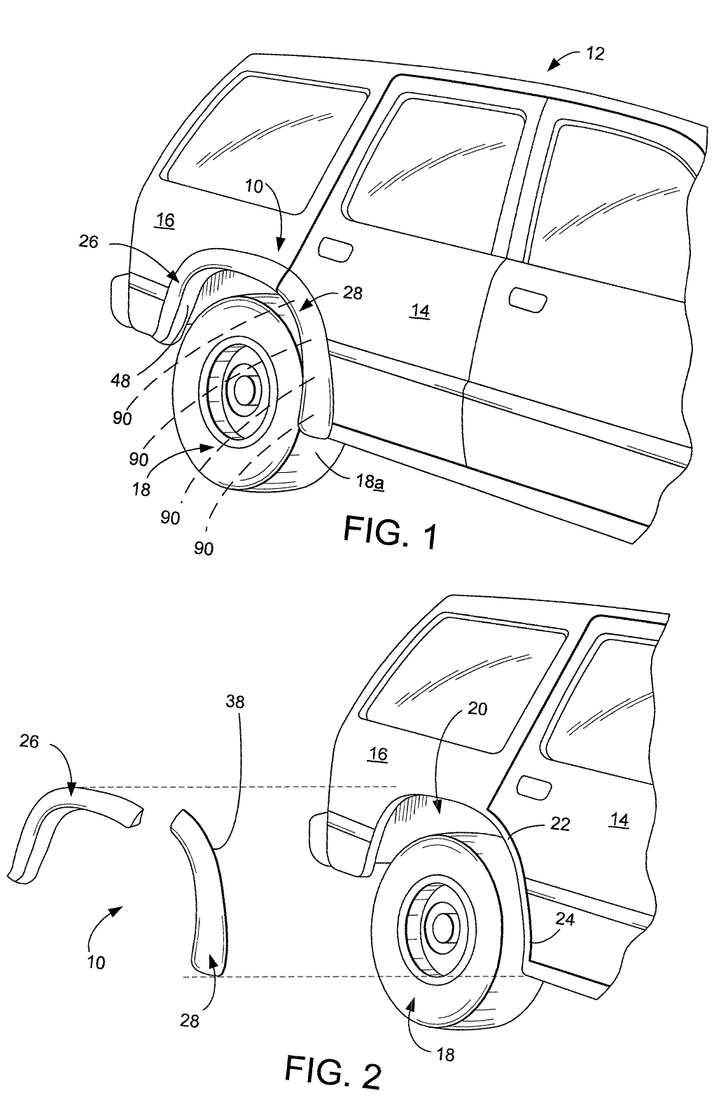

FIGS. 1 and 2 respectively show a vehicular body extension 10, or fender flare, on and removed from a representative vehicle 12, which as shown is a sport-utility vehicle. Vehicle 12 includes a door 14 and a rear panel or body portion 16. The side of wheel 18 typically is visible through a wheel well opening 20, which may be bounded by various portions of the vehicle, including body portion 16 and door 14.

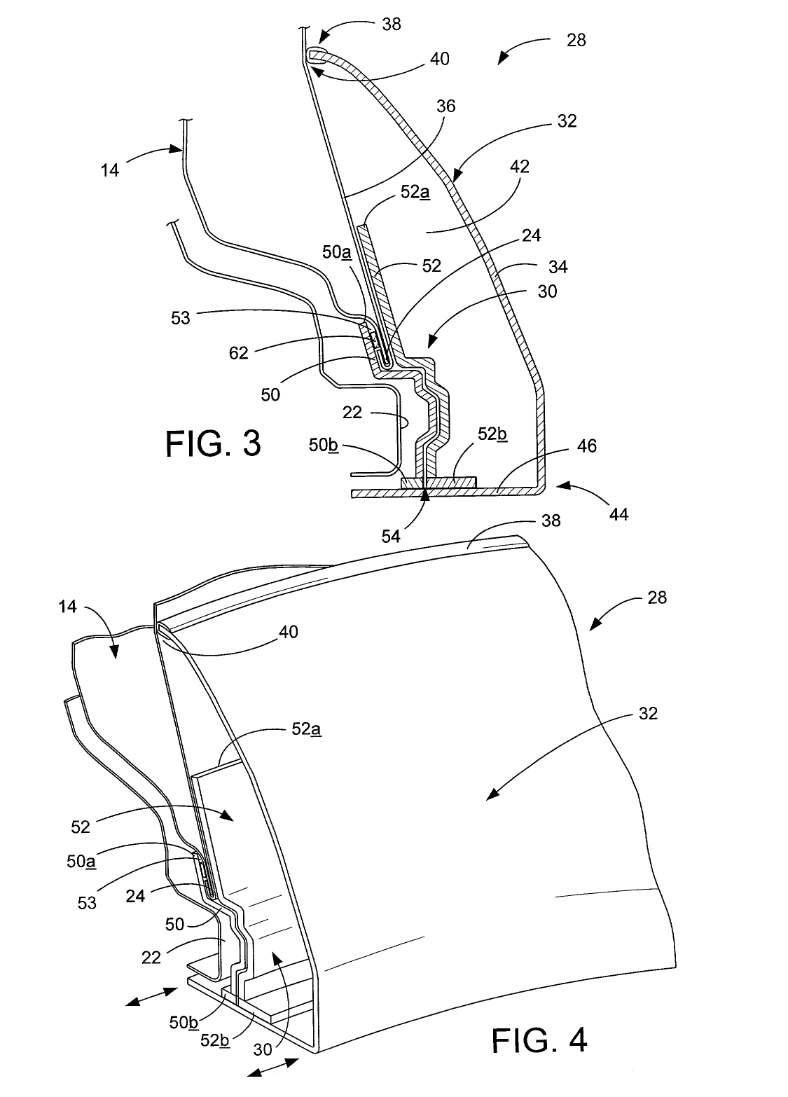

Door 14 typically forms an edge of wheel well opening 20, or is close to the wheel well opening and similarly shaped. For example, in the depicted vehicle, wheel well opening 20 is defined by body portion 16, and by a relatively narrow strip 22 of the body that is adjacent door 14. Door 14 includes an edge portion 24 (FIG. 2) that is next to strip 22, such that edge portion 24 is close to wheel well opening 20. Door edge 24 may bound wheel well opening 20, in addition to, or instead of, strip 22. In either case, edge portion 24 typically conforms to the contour of wheel well opening 20, and will thus also be referred to as a wheel well edge. Wheel well edge 24, like other edge portions of the door, typically is formed from sheet metal that is folded over and crimped, as best seen in FIG. 3. Edge 24 is normally much narrower in thickness than the portions of the vehicle door that are spaced inward from the edges.

The invention is a vehicular body extension 10, also known as a fender flare, which is secured to the vehicle body near wheel well opening 20. The depicted wheel well opening is at the rear of vehicle 12, though it will be understood that the invention may be used in connection with the front wheels of a vehicle as well. Two main components of the fender flare are a body flare piece 26, which is secured to body portion 16, and a door flare piece 28, which is secured to door 14. Typically, these pieces are configured so that, when the vehicle door is closed, they collectively form a substantially continuous trim structure, such as shown in FIG. 1. In other words, the two pieces are closely spaced, overlap, abut, or are otherwise configured so that they appear as a single unitary structure.

Various manufacturing methods may be employed to form fender flare 10, including molding, extrusion, casting or the like. Both the fender and door flare pieces are preferably formed of plastic, fiberglass, rubber, vinyl or another moldable or extrudable material. Often it will be desirable to form various parts of fender flare 10 so that they are somewhat resilient and flexible, as will be later explained.

Referring now to FIGS. 3 and 4, door flare piece 28 includes an attachment structure 30 configured to secure the door flare piece to vehicle door 14, and an outer trim structure 32. It will often be desirable that the outer trim structure at least partially conceal the attachment structure from view, as is the case with the door flare piece depicted in FIGS. 3 and 4. Aesthetic considerations typically determine the size and shape of outer trim structure 32. For example, the outer trim structure may be designed to provide added visual detail or refinement, draw attention to the wheels, break up the planar surfaces of the vehicle body, or make the vehicle look more bulky and aggressive. Function may play a role as well. For example, some motor vehicle laws require wide or tall tires that extend beyond normal wheel well openings to be covered by a fender structure. Aerodynamics, deflection of debris, and the size and shape of the vehicle are other factors that can affect the size and shape of the outer trim structure and other fender flare structures.

Outer trim structure 32 may extend outward from the vehicle, so that outer expanse 34 of the structure is spaced from surface 36 (FIG. 3) of the vehicle door. Typically, the outer expanse is generally parallel to the exterior surface of the vehicle body. Outer trim structure 32 also includes a door surface edge 38 that contacts the door surface at a location 40 spaced inward (i.e., away from the door edge toward the central portion of the door) from door edge 24. The degree to which edge 38 of outer trim structure 32 is spaced from the door edge may vary from less than an inch to several inches, as desired.

As indicated above, fender flare 10 preferably is constructed from a material that is somewhat flexible and resilient. One reason for this is that it will often be desirable to bias edge 38 of outer trim structure 32 into contact with the exterior surface of the vehicle body. In particular, door flare piece 28 may be, but is not necessarily, configured so that, when the door flare piece is installed on the vehicle, contact with the vehicle surface causes outer trim structure 32 to flex out of its uninstalled resting position relative to attachment structure 30. Due to the resilient character of the flare, this flexing biases edge 38 toward and into contact with the vehicle. The biasing produces several advantages, including reducing or eliminating gaps between the flare and vehicle, and reducing vibration and other movement of the flare relative to the vehicle body.

Outer trim structure 32 typically defines an at least partly hollow cavity 42 between door edge 24 and spaced-apart location 40 where door surface edge 38 contacts the door surface. The outer trim structure may be curved and bow outward, or have a planar or other desired shape. The shape and size of the cavity will vary accordingly. Instead of a hollow cavity, outer trim structure may be formed with a greater thickness to leave no cavity, or the cavity may be filled in with plastic, insulation or another material.

Opposite door surface edge 38, outer trim structure 32 has a wheel well edge 44. Wheel well edge 44 may include a strip member 46, which is similar to a corresponding strip member 48 (FIG. 1) provided on body flare piece 26. Typically, both strip members are formed to be generally perpendicular to the outer expanses of flare 10, which are normally parallel to the exterior surface of the vehicle. In addition, the strip members normally extend into the wheel well of the vehicle, and are curved to generally conform to the cylindrical road-contacting surface 18a of wheel 18, as best seen in FIG. 1. When the flare pieces are configured in this manner, the portions of flare 10 closest to wheel 18 define the wheel well opening through which the wheel is visible. Also, when the flare pieces extend into the wheel well, they offer protection against debris entering between the vehicle body and the fender flare. Though strip members 46 and 48 are advantageous in many settings, it is within the scope of the invention to have narrower strip members, or to not have any such structure extending into the wheel well.

As indicated above, door flare piece 28 includes an attachment structure 30 that secures the door flare piece to vehicle door 14. Referring again to FIGS. 3 and 4, attachment structure 30 includes opposed members 50 and 52, which are also respectively referred to as inner and outer vehicle attachment members. The opposed members are formed integrally with, or otherwise secured by an appropriate fastener to, outer trim structure 32. In the depicted embodiment, the opposed members have free ends 50a and 52a, which form an opening or channel 53 through which door edge 24 is received to secure the door flare piece to the vehicle door. Fixed ends 50b and 52b are fixed to the inward-facing surface of strip member 46, so that the opposed members are interconnected in intermediate region 54. Alternatively, one or both of opposed members 50 and 52 may be secured to outer expanse 34 instead of the strip member. For example, FIGS. 6 and 7 depict the use of rivets 60 for securing attachment structure 30 to outer expanse 34 of the depicted flare piece. It should be understood that other suitable fasteners may be used and are within the scope of the invention, including ultrasonic or other welds, adhesives and the like.

As seen in FIGS. 3 and 4, door edge 24 is received between opposed members 50 and 52 to mount door flare piece 28 in place on the door. The opposed members are typically configured so that they are at least slightly flexed apart from their pre-installed rest orientation when door edge 24 is received therebetween. The flexing may occur in the opposed members themselves, or as a result of a resilient hinge-like deformation occurring in intermediate region 54. The flexing biases opposed members 50 and 52 toward one another and into contact with door 14. Attachment structure 30 may thus be considered a clamp that operates on opposing sides of door edge 24 to secure the door flare piece in place.

Fender flare 10 typically includes a number of elongate structures conforming generally to the arcuate contour of wheel well 20. These structures may perform various functions, including enhancing the appearance of the vehicle and shielding against debris thrown off by wheel 18. The elongate character of these structures is shown more clearly in FIGS. 1 and 2 than in FIG. 3. For example, edge 38 may appear as an “end” of outer trim structure 32 in FIG. 3, though FIG. 2 reveals that this edge is elongate and generally follows the contour of wheel well opening 20.

Opposed members 50 and 52 and intermediate region 54 are typically elongate as well, conforming generally to the length of door edge 24. These components thus collectively form an elongate channel or slot 53 for receiving the door edge, as seen in cross-section in FIG. 3. When attachment structure 30 is configured in this manner, it operatively engages door edge 24 (e.g., clamps or grips the door edge) along substantially its entire arcuate length. Alternatively, door edge 24 may be clamped at discrete locations along the curved length of the door edge, for example by providing spaced-apart pinch points along channel 53.

Further advantages result from other features of attachment structure 30. Generally, the attachment structure permits the fender flare to be installed without structural modification of the vehicle. Modification occurs in existing flare installation methods as a result of performing operations on the structure of the vehicle door. Introducing holes into the vehicle is a structural modification that is often required to install existing fender flares. The holes typically are drilled through the door at or near the door edge to accommodate screws, rivets or other mechanical fasteners. Abrading mounting surfaces on the vehicle to provide an improved gripping surface is another example of structural modification. Still another example of structural modification is affixing a separate flare-mounting bracket on the door.

To install the door flare piece depicted in FIGS. 1-4, holes do not need to be drilled into or through the door. The door edge does not have to be filed to provide it with a rough gripping surface. Threaded fasteners are not needed to clamp the door flare piece in place. Instead, door flare piece 28 may be installed without structurally modifying the vehicle door. As will be later explained in more detail with respect to FIGS. 4, 6 and 7, the door flare piece may simply be slid onto door edge 24 so that the door edge is received within channel 53.

The ability to install door flare piece 28 without structurally modifying vehicle 12 may be desirable for a number of reasons. First, operations that structurally modify the vehicle (e.g., drilling, cutting, filing, affixing mounting brackets, etc.) add extra steps to installation and make the process more time consuming. These steps also invariably require use of hand or power tools. Further, most structural modifications occurring during conventional installation methods are irreversible, requiring a heightened degree of caution on the part of the installer. Finally, given that the flare may be uninstalled at some point, the modifications themselves can be undesirable or even prohibited. For example, lease agreements often prohibit or impose penalty fees for structural modification of the leased vehicle.

In the fender flare depicted in FIGS. 1-4, “no-modification” installation is facilitated by the unique way in which component parts of attachment structure 30 are configured. In particular, as discussed above, opposed members 50 and 52 each have free ends 50a and 52a, and interconnected ends 50b and 52b. This configuration may be extended or wrapped around door edge 24 and operatively engaged with opposing sides of the door, without drilling holes through the door (e.g., to accommodate screws) or otherwise structurally modifying the door.

As discussed above, attachment structure 30 itself can firmly secure door flare piece 28 to door 14. However, to further strengthen the connection, glue, tape or other suitable adhesive-type solutions may be employed. For example, double-sided tape 62 may be inserted between the inside of door edge 24 and one of opposed members 50 or 52, as depicted in FIG. 3. Use of adhesive tape will be described more particularly with reference to FIGS. 6 and 7.

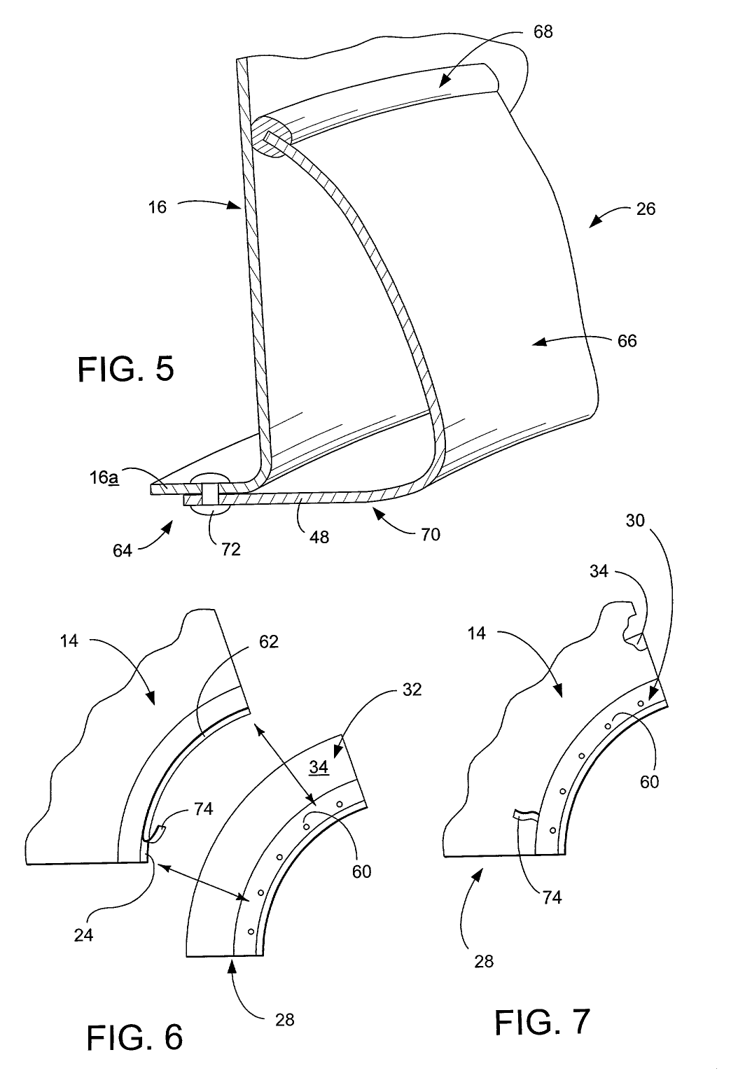

Referring now to FIG. 5, body flare piece 26 will be described. Similar to door flare piece 28, the body flare piece may include an attachment structure 64 for mounting the flare piece to the vehicle; an outer trim structure 66 raised off the surface of the vehicle; a vehicle body edge 68 biased into contact with the exterior surface of the vehicle; and a wheel well edge 70. Outer trim structure 66 may serve various aesthetic and functional purposes, similar to those described above with reference to door flare piece 28, and typically is affixed to the vehicle in a visible location near the wheel well.

Body flare piece 26 may be secured to wheel well flange 16a, which bounds the wheel well. Typically, several holes are provided at spaced intervals along the arcuate length of body portion 16 through flange 16a. These holes are often provided through the flange during initial manufacture of the vehicle. As depicted in FIG. 5, a mechanical fastener, such as rivets 72, may be passed through these holes and through aligned holes provided in strip member 48, to secure the body flare piece to the vehicle.

The previously discussed issues relating to holes and other structural modifications are not as applicable to flange 16a as they are to door edge 24, as the flange cannot be viewed from most vantage points during normal operation of the vehicle. Further, as just indicated, the holes in flange 16a are often introduced into the vehicle during initial manufacture, instead of during an aftermarket customization process. Accordingly, it will often be desirable to use the rivet fastening method shown in FIG. 5, despite the many advantages of the attaching structure described with reference to FIGS. 3 and 4. However, it should be appreciated that body flare piece 26 may be provided with vehicle attachment structures similar to those of door flare piece 28. For example, body flare piece 26 may be provided with an elongate channel having opposed sidewalls between which an edge of body portion 16 is received.

Referring now to FIGS. 6 and 7, and various ones of the preceding figures, a method of installing a fender flare according to the present invention will be described. As depicted and described above with reference to FIGS. 3 and 5, the method includes securing body and door flare pieces to respective exterior portions of a vehicle. As more fully described below, securing the door flare piece to the vehicle door may be accomplished by partially engaging door edge 24 between opposed members 50 and 52, and then sliding the door flare piece along the door edge until the door edge is fully received within the elongate slot defined by the opposed members. The body flare piece may be mounted onto the vehicle body before or after the door flare piece, and may be secured to the vehicle using rivets, screws and the like (FIG. 5), or with a channel-type attachment mechanism, as described with reference to FIGS. 3 and 4.

FIG. 6 depicts the use of adhesive tape to aid in securing door flare piece 28 to vehicle door 14. As shown in the figure, a length of double-sided tape 62 may be applied to one side of door 14, normally on or near crimped edge 24, prior to positioning the door flare piece on the vehicle door. Typically, the tape is applied to the inside of door edge 24, although other mounting positions may additionally or alternatively be used. Thus, when the door edge is positioned within the elongate channel formed by opposed members 50 and 52 (FIG. 3), the length of tape is positioned between the door edge and one of the opposed members. The tape may instead be applied first to the inward facing surface of one of opposed members 50 and 52.

Regardless of whether the tape is first applied to the door or to the door flare piece, it will often be desirable to initially leave the backing in place on the other side of the length of tape. The door flare piece may then be engaged with door edge 24, typically by first engaging the door flare piece with one end of the door edge. The door flare piece is then slid along the door edge (the sliding movement is indicated with arrows in FIG. 3) until it is in the desired position, or at least nearly so. Because one side of the tape is still covered by backing, the installer at this point may easily adjust the alignment of the door flare piece, by further sliding the door flare piece or making other adjustments. Once the desired alignment is achieved, the remaining backing is removed from the tape. Opposed members 50 and 52 may then be pressed together with an external clamping force to fully engage the tape with the contacted surfaces of the vehicle and flare. Alternatively, the flexing of the opposed members may provide enough inward-directed pressure to fully engage the tape.

As shown in FIGS. 6 and 7, removing a small portion 74 of the remaining side of backing may aid in the application of adhesive tape 62. When the door flare piece is placed on the vehicle, this disengaged portion of backing should extend out from between the door edge and the inward facing wall of the edge-receiving elongate channel, as shown in FIG. 7. The installer may easily pull on the hanging piece to remove the backing once the flare piece is in its desired position.

The method just described is typically performed as an aftermarket operation, after initial manufacture of the vehicle, and is less complicated than existing installation methods. One such existing method involves temporarily affixing the door flare piece to the vehicle door prior to mounting the body flare piece on the body of the vehicle. This is required to ensure proper alignment of the two pieces. After alignment is achieved, the door flare piece is removed in order to drill holes through the door. The door flare piece is then reattached, again using a temporary fastener, to hold the door flare in place while holes are drilled through it to align with the holes drilled in the door. Rivets are then engaged within the holes to secure the door flare piece in place on the door.

By contrast, the method described above requires no specialized skills, and can be successfully completed by nearly anyone in a few simple steps, which are normally performed without the use of tools. The present method does not require that one piece be mounted prior to the other, nor does it require extra steps to ensure proper alignment. As discussed above, the position of the flare may be easily adjusted as part of the basic mounting procedure. In addition, the present method may be performed without drilling holes into or otherwise structurally modifying the vehicle on which the fender flare is to be installed. As discussed above, avoiding modification simplifies installation, and is often preferred by those who lease vehicles or plan to later remove the fender flare.

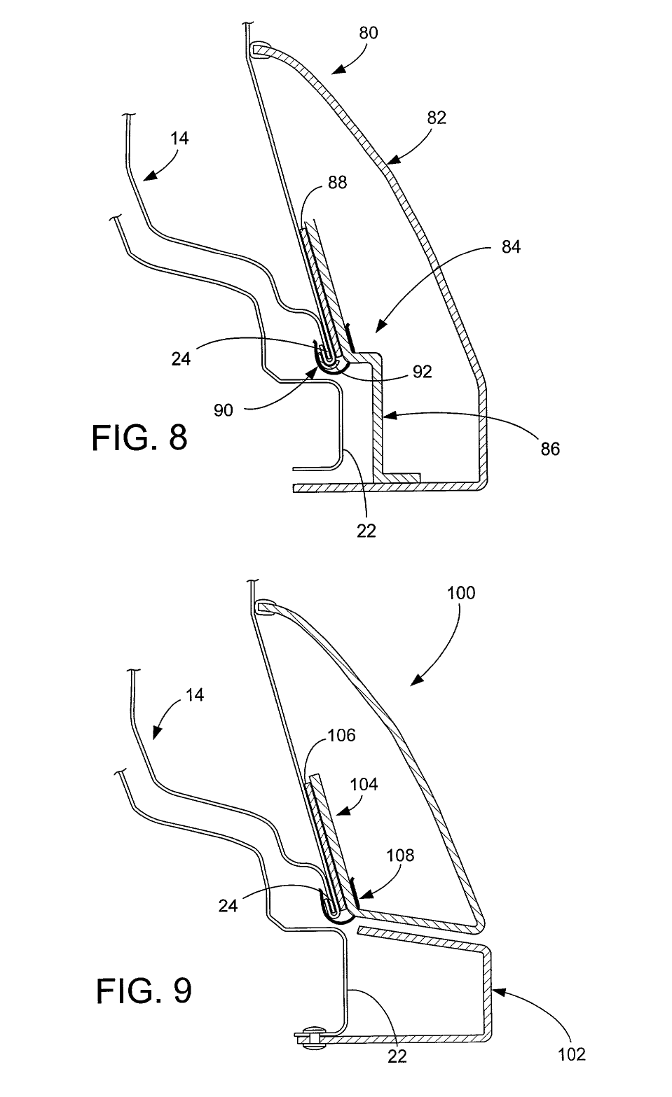

FIG. 8 depicts another embodiment of a door flare piece 80 according to the present invention. Door flare piece 80 includes an outer trim structure 82, similar to the outer trim structure described with reference to FIG. 3, and a vehicle attachment structure 84 configured to secure door flare piece 80 to vehicle door 14 near door edge 24. Vehicle attachment structure 84 includes an inner member 86 secured to, or provided integrally with outer trim structure 82. Inner member 86 and outer trim structure 82 typically are elongate structures that extend along substantially the entire length of door edge 24.

Door flare piece 80 typically is secured to door 14 by first applying an adhesive 88 (e.g., double-sided tape) to the outer surface of door edge 24. The door flare piece is then applied to door 14 so that an inward-facing surface of inner member 86 engages adhesive 88. As indicated, vehicle attachment structure 84 may further include a clip 90 to provide a clamping, or inwardly directed biasing force for securing the door flare piece to the door. Use of adhesive 88 is often desirable, though it is within the scope of the invention to use one or more clips 90 without adhesive to secure the door flare piece to the door. Similar to the previous embodiments, the depicted clip arrangement allows the door flare piece to be installed without structurally modifying the vehicle. Also, one or more clips may be used instead of, or in addition to, the securing mechanisms described above. Typically, when clips are employed, several clips 90 are provided at spaced-apart locations along the curved length of door edge 24. For example, FIG. 1 depicts use of four clips 90 to secure door flare piece 28 to door 14, though more or less than four clips may be used. The clips may be formed integrally with the door flare piece, or, as shown in FIG. 8, formed separately and inserted through slots (not shown) provided through inner member 86 at appropriate locations. When separately formed clips are used, they are normally put in place after door flare piece 80 has been applied to the door by engaging inner member 86 with adhesive 88. Regardless of the particular clip configuration, it will be understood that the clip(s) provides, either alone or in combination with the other attaching structures, opposed portions for receiving door edge 24. Typically, the clip is made from a resilient material. A protective layer, such as scratch-resistant Mylar tab 92, may be provided between the door edge and the clip, to protect the door edge. Alternatively, or additionally, the clips may themselves be made from a material that protects the door edge from being scratched.

FIG. 9 depicts yet another embodiment of a door flare piece 100 according to the invention. The figure also depicts a portion 102 of an alternately configured body flare piece. As with the embodiment of FIG. 8, door flare piece 100 is secured to door via an inner member 104, adhesive layer 106, and a clip 108. It should be understood that the clips, adhesive and protective layer shown in FIGS. 8 and 9 are depicted schematically, such that the depicted dimensions may be exaggerated or otherwise varied from what would be appropriate for a given implementation of the invention. These structures may be configured to have any appropriate size and shape.

Referring still to FIG. 9, unlike the previously described door flare pieces, the depicted door flare piece does not define the innermost edge of the fender flare, so as to bound the wheel well opening. Instead, a narrow portion 102 of the body flare piece (narrow relative to the rest of the body flare piece) extends along strip 22 of the vehicle body. This portion of the body flare piece is the innermost portion of the fender flare and at least partly defines, or bounds the wheel well opening. A similar arrangement is shown in FIGS. 1, 5 and 6 of U.S. Pat. No. 5,238,268 to Logan, the disclosure of which is incorporated herein by this reference. Any of the other fender flares described above in accordance with the present invention may be modified to include these features.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

I claim:

1. A fender flare, comprising:
a body flare piece configured to be secured to a body portion of a vehicle near a wheel well opening of the vehicle; and
a door flare piece configured to be secured to a door of the vehicle near the wheel well opening, wherein the body flare piece and door flare piece are configured to collectively form an at least substantially continuous trim structure when the door of the vehicle is closed, the door flare piece comprising:
an inner vehicle attachment member; and
an outer vehicle attachment member, wherein the vehicle attachment members define a channel therebetween and are adapted to receive an edge portion of the door in the channel to secure the door flare piece to the door.

2. The fender flare of claim 1, wherein the vehicle attachment members are adapted to secure the door flare piece to the door without requiring structural modification of the door.

3. The fender flare of claim 2, wherein the vehicle attachment members are adapted to secure the door flare piece to the door without introducing holes into the door.

4. The fender flare of claim 2, wherein the vehicle attachment members are adapted to secure the door flare piece to the door without securing a mounting bracket to the door.

5. The fender flare of claim 1, wherein the door flare piece is adapted to be secured to the door of the vehicle free from holes adapted to receive a mechanical fastener to mount the door flare piece on the door.

6. The fender flare of claim 1, wherein the vehicle attachment members form part of a clamping structure that extends around the edge portion of the door to secure the door flare piece to the vehicle.

7. The fender flare of claim 1, wherein the channel is substantially as long as the edge portion of the door.

8. The fender flare of claim 1, wherein the door flare piece includes an outer trim structure that at least partially conceals the vehicle attachment members when the door flare piece is secured to the door.

9. The fender flare of claim 8, wherein the outer trim structure includes a door surface edge configured to contact an exterior surface of the door at a location spaced-apart from the channel.

10. The fender flare of claim 9, wherein the door flare piece is adapted so that the door surface edge of the outer trim structure is biased toward the exterior surface of the door when the door flare piece is secured to the door.

11. The fender flare of claim 8, wherein the outer trim structure is adapted to define a cavity when the door flare piece is secured to the door of the vehicle, the cavity being at least partially bounded by the door and by an interior wall of the outer trim structure.

12. The fender flare of claim 8, wherein the outer trim structure is adapted to conceal the vehicle attachment members from view when the door of the vehicle is closed.

13. The fender flare of claim 1, wherein the vehicle attachment members include inward-facing planar surfaces adapted to contact opposed planar surfaces on the edge portion of the door to secure the door flare piece to the vehicle.

14. The fender flare of claim 1, wherein the vehicle attachment members are shaped to conform at least substantially to the shape of an edge of the door upon which the door flare piece is mounted.

15. The fender flare of claim 1, wherein the door flare piece includes a wheel well edge adapted to at least partly define the wheel well opening when the door flare piece is secured to the door of the vehicle.

16. The fender flare of claim 1, wherein the body flare piece includes a wheel well edge adapted to at least partly define the wheel well opening when the body flare piece is secured to the body of the vehicle.

17. The fender flare of claim 1, wherein the vehicle attachment members are biased toward each other and adapted to be biased against the door when the door flare piece is secured to the vehicle.

18. A fender flare, comprising:
a body flare piece configured to be secured to a body portion of a vehicle so that the body flare piece at least partly defines a wheel well opening of the vehicle; and
a door flare piece configured to be secured to a door of the vehicle so that the door flare piece at least partly defines the wheel well opening, wherein the body flare piece and door flare piece are configured to collectively form an at least substantially continuous trim structure when the door of the vehicle is closed, the door flare piece including:
a vehicle attachment structure including opposed portions adapted to at least partially receive the door of the vehicle therebetween to secure the fender flare to the vehicle, the vehicle attachment structure being configured to permit installation of the door flare piece without requiring structural modification to the door of the vehicle; and
a flare member configured to at least substantially conceal the vehicle attachment structure from view when the door of the vehicle is closed.

19. The fender flare of claim 18, further comprising a clip configured to at least partially receive the door of the vehicle therein to secure the door flare piece to the door of the vehicle.

20. The fender flare of claim 18, further comprising a plurality of clips configured to secure the door flare piece to the door of the vehicle at spaced apart locations along an edge portion of the door of the vehicle.

21. The fender flare of claim 18, wherein the vehicle attachment structure is adapted to secure the door flare piece to the door without introducing holes into the door.

22. The fender flare of claim 18, wherein the vehicle attachment structure is adapted to secure the door flare piece to the door without securing a mounting bracket to the door.

23. The fender flare of claim 18, wherein the door flare piece is adapted to be secured to the door of the vehicle free from holes adapted to receive a mechanical fastener to mount the door flare piece on the door.

24. The fender flare of claim 18, wherein the opposed portions at least partially define a continuous elongate channel adapted to receive an edge of the door.

25. The fender flare of claim 18, wherein the opposed portions are resiliently biased inward toward each other and adapted to be biased against an edge portion of the door when the door flare piece is installed on the vehicle.

26. A method of installing a fender flare, comprising:
providing a fender flare including a body flare piece that is adapted to be mounted on a body of a vehicle, and a door flare piece that is adapted to be mounted on a door of the vehicle;
securing the body flare piece to the body of the vehicle near a wheel well opening of the vehicle; and
securing the door flare piece to the door of the vehicle near the wheel well opening, so that the body flare piece and door flare piece form an at least substantially continuous trim structure when the door of the vehicle is closed, wherein securing the door flare piece to the door includes causing the door to be at least partially received between opposed inner and outer vehicle attachment members of the door flare piece, so that the door is retained therebetween.

27. The method of claim 26, wherein securing the door flare piece to the door of the vehicle requires no structural modification of the door.

28. The method of claim 27, wherein securing the door flare piece to the door is performed without introducing holes into the door.

29. The method of claim 27, wherein securing the door flare piece to the door is performed without using a mounting bracket adapted to secure the door flare piece to the door.

30. The method of claim 26, wherein securing the door flare piece to the door of the vehicle includes positioning the door flare piece so that an edge of the door is received within an elongate channel defined by the inner and outer vehicle attachment members.

31. The method of claim 30, wherein positioning the door flare piece includes partially engaging the edge of the door within the elongate channel, and then sliding the door flare piece along the door edge to place the door flare piece in an installed position.

32. The method of claim 30, further including adhesively securing at least one of the vehicle attachment members to the door.

33. The method of claim 32, wherein the at least one of the vehicle attachment members is adhesively secured to the door using adhesive tape.

34. The method of claim 33, wherein the adhesive tape is double-sided, and wherein a backing material of the tape is at first only partially removed to allow positional adjustment of the door flare piece before the backing material is completely removed.

35. The method of claim 26, wherein securing the door flare piece to the door includes positioning an edge of the door of the vehicle within a vehicle attachment structure that wraps around the edge of the door to engage opposing sides of the edge of the door.

36. A fender flare, comprising:
a body flare piece configured to be secured to a body of a vehicle so that the body flare piece at least partly defines a wheel well opening of the vehicle; and
a door flare piece configured to be secured to a door of the vehicle so that the door flare piece at least partly defines the wheel well opening, wherein the body flare piece and door flare piece are configured to collectively form an at least substantially continuous trim structure when the door of the vehicle is closed, the door flare piece including means for securing the door flare piece to the vehicle door without requiring holes or other structural modifications to the door.

37. A vehicle, comprising:
a body;
a door;
a wheel well opening defined by at least one of the body and the door; and
a fender flare, comprising:
a body flare piece secured to the body near the wheel well opening; and
a door flare piece secured to the door near the wheel well opening, wherein the body flare piece and door flare piece are configured to collectively form an at least substantially continuous trim structure when the door of the vehicle is closed, and wherein an edge of the door is received within a channel defined by the door flare piece to secure the door flare piece to the door.

38. The vehicle of claim 37, wherein the door flare piece is configured to be mounted onto the door without structurally modifying the door.
